(19) United States
(12) Patent Application Publication
(10) Pub. No.: US 2019/0016211 A1
(43) Pub. Date: Jan. 17, 2019

(54) VEHICLE FILLER NECK MOUNTED FUEL FILTER SYSTEM

(71) Applicant: Filtration Sensations, LLC, Twinsburg, OH (US)

(72) Inventor: MATTHEW NOVAK, TWINSBURG, OH (US)

(21) Appl. No.: 16/038,159

(22) Filed: Jul. 17, 2018

Related U.S. Application Data
(60) Provisional application No. 62/533,662, filed on Jul. 17, 2017.

(51) Int. Cl. B60K 15/04; B60K 15/03

(52) U.S. Cl. CPC B60K 15/04; B60K 2015/03236; B60K 2015/047; B60K 15/03

(57) ABSTRACT

A vehicle filler neck mounted fuel filter system (“filter system”) is disclosed. The filter system may be configured to filter undesirable particulate matter and impurities from entering a vehicle's gas tank from a gas pump nozzle. The filter system may provide a filter tube that incorporates the primary filtering elements (e.g. mesh) and slides into a vehicles filler neck, secured and mounted in an assembly that can include a filter tube holder, compression sleeve, a pressure valve assembly and other backpressure-alleviating features, and a cap. A filter system can be sized and configured to accommodate a wide array of form factors and vehicles, including gasoline and diesel engine vehicles and high-flow commercial vehicles.

### RELATED APPLICATIONS

The following related U.S. Patent Applications, filed in the name of Matthew Novak, assigned to the assignee of the present application, are hereby incorporated by reference:
U.S. Provisional Patent Application No. 62/533,662, filed Jul. 17, 2017, entitled “VEHICLE FILLER NECK MOUNTED FUEL FILTER SYSTEM”, having Attorney Docket No. NOVAK.PT.01, and referred to herein as “the '662 disclosure”.

### FIELD OF THE INVENTION

The present disclosure generally relates to fuel filters. More specifically, various embodiments of the present disclosure may relate to devices and systems for filtering fuel as it is dispensed into a vehicle.

### BACKGROUND

Combustion engine vehicles such as cars as trucks are commonly fueled from fuel storage tanks at commercial gas stations. Such storage tanks can harbor a nontrivial amount of, dirt, sludge, sediment, and other particulate matter that, if left in the fuel stream, can have negative effects on a vehicle fuel system. Such undesirable matter can be found in the dispensable fuel volume even in quiescent tanks, but it can be particularly stirred up by events such as a tanker truck refill.

Gas stations may be subject to regulatory regimes that require filtration systems to decrease the concentration of undesired particulates. However, an individual vehicle owner has little means to determine the compliance regime to which a particular station is subject. This is particularly true when traveling long distances and filling up in unfamiliar locales. The user also has no way of knowing if a gas station actually complies with the regulations or whether the station has maintained its filters. Ultimately, the user puts their vehicle at risk because they do not know if the actual particulate count of the dispensed fuel is within acceptable limits.

Vehicles frequently have their own internal filtration systems, as well. However, an internal fuel filter is often placed immediately before the fuel injectors in the fuel delivery system after the gas tank, fuel pump, and associated fuel lines. That means any impurities that exit the nozzle of a gas station pump will necessarily be deposited into the vehicle's gas tank along with the fuel. Such sediments and sludge can be deleterious to the gas tank and other fuel system components, even if the undesirable matter is largely prevented (by the fuel filter) from reaching the combustion chamber.

Additionally, fuel filters have varying effectiveness at filtering out contaminants at various particulate sizes. A filter with 99% efficiency, when functioning optimally, will still pass 1% of impurities at or above its size rating. Fuel filters accumulate impurities over time, which can cause efficiency to drop, allowing undesirable matter from the gas tank to enter the combustion system and reduce the lifespan of engine components. The dirtier the upstream fuel from the gas tank, the quicker the accumulation of impurities in the filter.

While internal fuel filters are generally designed to be replaceable, accessing and replacing one can be a non-trivial (and potentially costly) task. Therefore, users would prefer to delay doing so by providing the filter a relatively cleaner stream of incoming fuel.

Therefore, a need exists for an additional filtration stage between the gas station pump and the vehicle's gas tank, such as a fuel filter that can be mounted into a vehicle's fuel filler neck.

### SUMMARY

A vehicle filler neck mounted fuel filter system may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present disclosure describes a vehicle filler neck mounted fuel filter that can provide a filtration stage at the entry point to the vehicle's gas tank. In one example of a vehicle filler neck mounted fuel filter, the filter assembly can include: a cap; a pressure valve casing that houses a spring, a spring retention ring, and a pressure valve base; a filter tube; a filter tube holder; and, a compression sleeve.

In such a system, a compression sleeve may be inserted into the mouth of a gas tank, into the filler neck, with its seating ring against the outer edge of the mouth of the gas tank. A filter tube may itself incorporate threading features that allow it to be screwed directly into a compression sleeve without a filter holder component, or a filter tube holder may be screwed, using integrated external threads, into matching internal threads on the interior wall of the compression sleeve. With a filter tube holder, the filter tube can be inserted into the through hole in the holder's center to rest on a filter tube seating shelf.

At the mouth of a filter tube, a pressure valve system can keep the tube assembly in place while allowing for the release of back pressure from tank vapors. A cap may interface with the filter system, holding the pressure valve assembly and sealing the entire assembly when affixed. A filter tube can have a lattice that supports a filter mesh. Such mesh can provide the filtering mechanism as fuel passes through it.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings are merely illustrative of various embodiments, elements, and aspects of the present disclosure, and are not intended to perfectly reflect scale, depth, dimension, orientation, ordering, thickness, or shape in any limiting way, and are not to be construed to limit the scope of patent protection afforded in any claim of a patent issuing here from, which scope is to be defined by the claims and the equivalents thereof.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates an exploded view of an exemplary non-commercial flow rate, gasoline-engine vehicle filler neck mounted fuel filter having a solid wall filter tube seating ring, in accordance with various embodiments.

FIG. 1B illustrates an exploded view of an exemplary non-commercial flow rate, gasoline-engine vehicle filler neck mounted fuel filter having a separated wall filter tube seating ring, in accordance with various embodiments.

FIG. 1C illustrates an exploded view of another exemplary non-commercial flow rate, gasoline-engine vehicle filler neck mounted fuel filter having having a solid wall filter tube seating ring, in accordance with various embodiments.

FIG. 1D illustrates an exploded view of an exemplary non-commercial flow rate, gasoline-engine vehicle filler neck mounted fuel filter having having a conical filter tube seating ring, in accordance with various embodiments.

FIG. 1E illustrates an exploded view of an exemplary non-commercial flow rate, gasoline-engine vehicle filler neck mounted fuel filter having having a conical filter tube seating ring and mesh-only filter tube, in accordance with various embodiments.

FIG. 1F illustrates an exploded view of an exemplary non-commercial flow rate, diesel-engine vehicle filler neck mounted fuel filter having a solid wall filter tube seating ring, in accordance with various embodiments.

FIG. 1G illustrates an exploded view of an exemplary non-commercial flow rate, diesel-engine vehicle filler neck mounted fuel filter having a separated wall filter tube seating ring, in accordance with various embodiments.

FIG. 1H illustrates an exploded view of an exemplary commercial flow rate, diesel-engine vehicle filler neck mounted fuel filter, in accordance with various embodiments.

FIG. 1I illustrates an exploded view of an exemplary commercial flow rate, diesel-engine vehicle filler neck mounted fuel filter with a short length filter tube, in accordance with various embodiments.

FIG. 2A illustrates a perspective view of an exemplary cap, in accordance with various embodiments.

FIG. 2B illustrates a side elevation view of an exemplary cap, in accordance with various embodiments.

FIG. 2C illustrates a bottom plan view of an exemplary cap, in accordance with various embodiments.

FIG. 3A illustrates a perspective view of an exemplary pressure valve casing, in accordance with various embodiments.

FIG. 3B illustrates a side elevation view of an exemplary pressure valve casing, in accordance with various embodiments.

FIG. 3C illustrates a top plan view of an exemplary pressure valve casing, in accordance with various embodiments.

FIG. 4A illustrates a perspective view of an exemplary pressure valve assembly, in accordance with various embodiments.

FIG. 4B illustrates a side elevation view of an exemplary pressure valve assembly, in accordance with various embodiments.

FIG. 4C illustrates a perspective view of an exemplary spring retention ring, in accordance with various embodiments.

FIG. 4D illustrates a side elevation view of an exemplary spring retention ring, in accordance with various embodiments.

FIG. 4E illustrates a top plan view of an exemplary spring retention ring, in accordance with various embodiments.

FIG. 4F illustrates a perspective view of an exemplary pressure valve base, in accordance with various embodiments.

FIG. 4G illustrates a side elevation view of an exemplary pressure valve base, in accordance with various embodiments.

FIG. 4H illustrates a top plan view of an exemplary pressure valve base, in accordance with various embodiments.

FIG. 5A illustrates a side elevation view of an exemplary non-commercial flow rate, gasoline-engine vehicle filter tube having a solid wall filter tube seating ring, in accordance with various embodiments.

FIG. 5B illustrates a top plan view of an exemplary non-commercial flow rate, gasoline-engine filter tube having a solid wall filter tube seating ring, in accordance with various embodiments.

FIG. 5C illustrates a side elevation view of an exemplary non-commercial flow rate, diesel-engine filter tube having a solid wall filter tube seating ring, in accordance with various embodiments.

FIG. 5D illustrates a top plan view of an exemplary non-commercial flow rate, diesel-engine filter tube having a solid wall filter tube seating ring, in accordance with various embodiments.

FIG. 5E illustrates a side elevation view of an exemplary commercial flow rate, diesel-engine short length filter tube, in accordance with various embodiments.

FIG. 5F illustrates a top plan view of an exemplary commercial flow rate, diesel-engine short length filter tube, in accordance with various embodiments.

FIG. 6A illustrates a perspective view of an exemplary filter tube holder, in accordance with various embodiments.

FIG. 6B illustrates a side elevation view of an exemplary filter tube holder, in accordance with various embodiments.

FIG. 6C illustrates a bottom plan view of an exemplary filter tube holder, in accordance with various embodiments.

FIG. 7A illustrates a perspective view of an exemplary compression sleeve, in accordance with various embodiments.

FIG. 7B illustrates a side elevation view of an exemplary compression sleeve, in accordance with various embodiments.

FIG. 7C illustrates a top plan view of an exemplary compression sleeve, in accordance with various embodiments.

FIG. 8 illustrates a perspective view of an exemplary tether, in accordance with various embodiments.

FIG. 9A illustrates a perspective view of an exemplary filler tube mouth and seating ring, in accordance with various embodiments.

FIG. 9B illustrated a side elevation view of an exemplary filler tube mouth and seating ring, in accordance with various embodiments.

FIG. 9C illustrates a perspective view of another exemplary filler tube mouth and seating ring, in accordance with various embodiments.

FIG. 9D illustrated a side elevation view of another exemplary filler tube mouth and seating ring, in accordance with various embodiments.

FIG. 10 depicts a flow diagram of an exemplary method for installing and using a vehicle filler neck mounted fuel filter, in accordance with various embodiments.

### DETAILED DESCRIPTION

The following detailed description refers to the accompanying drawings. Wherever possible, the same reference numbers are used in the drawings and the following description to refer to the same or similar elements.

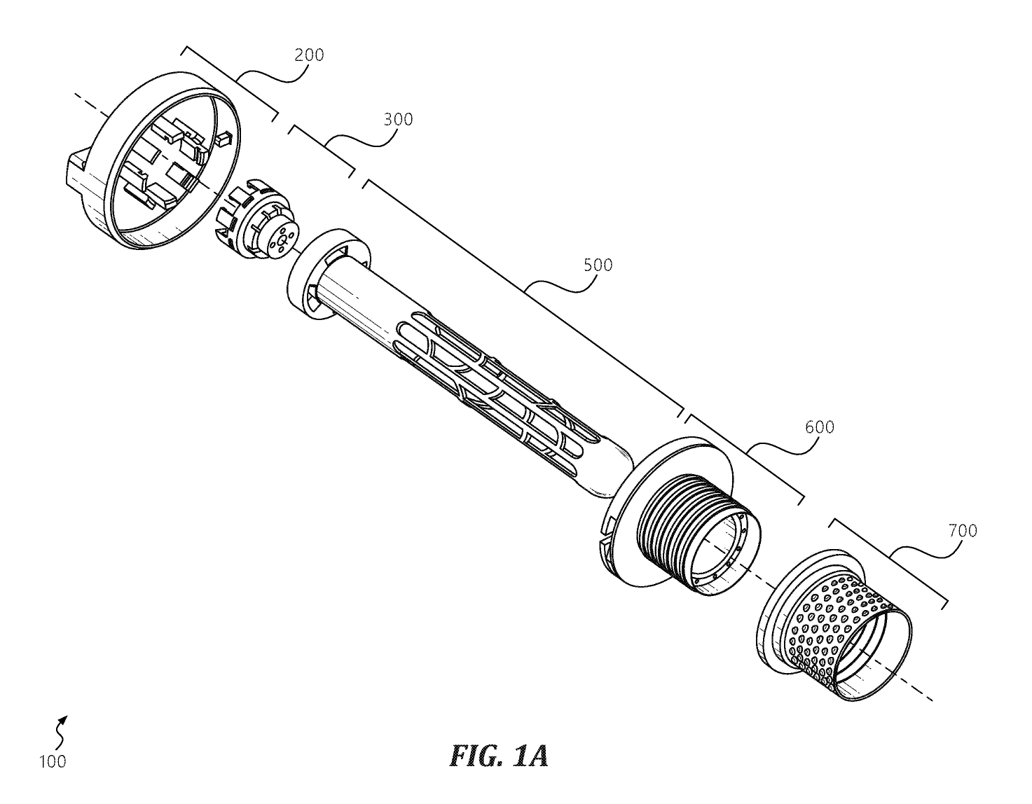

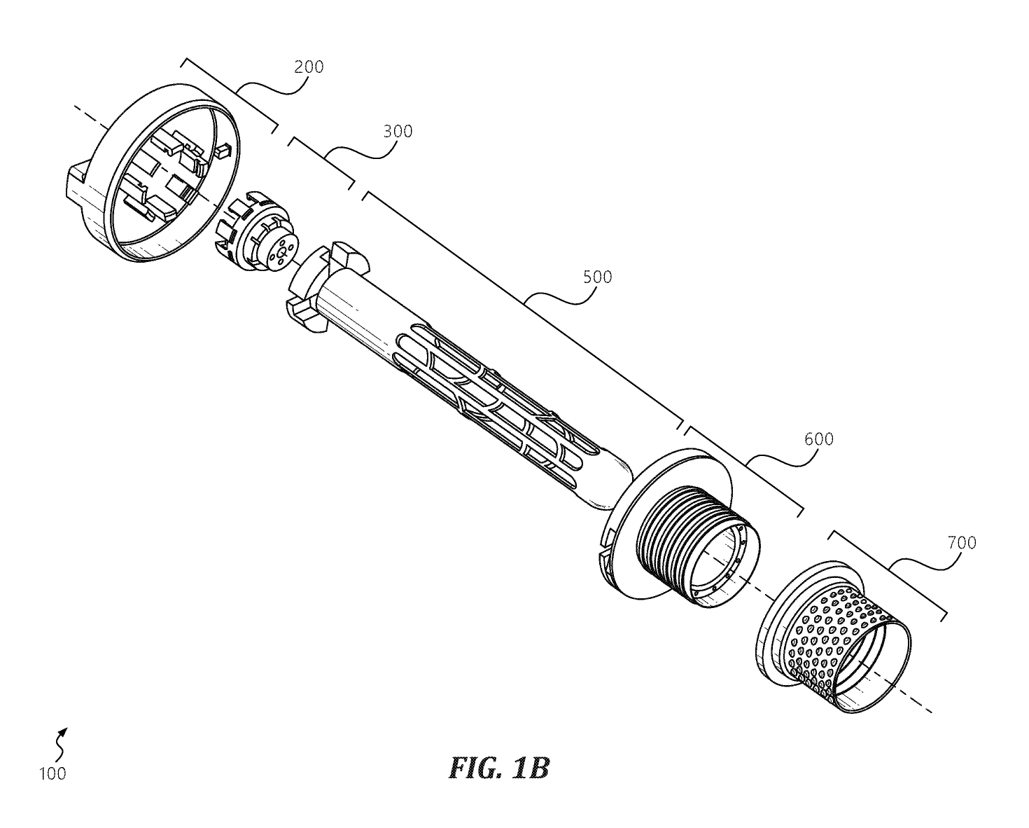

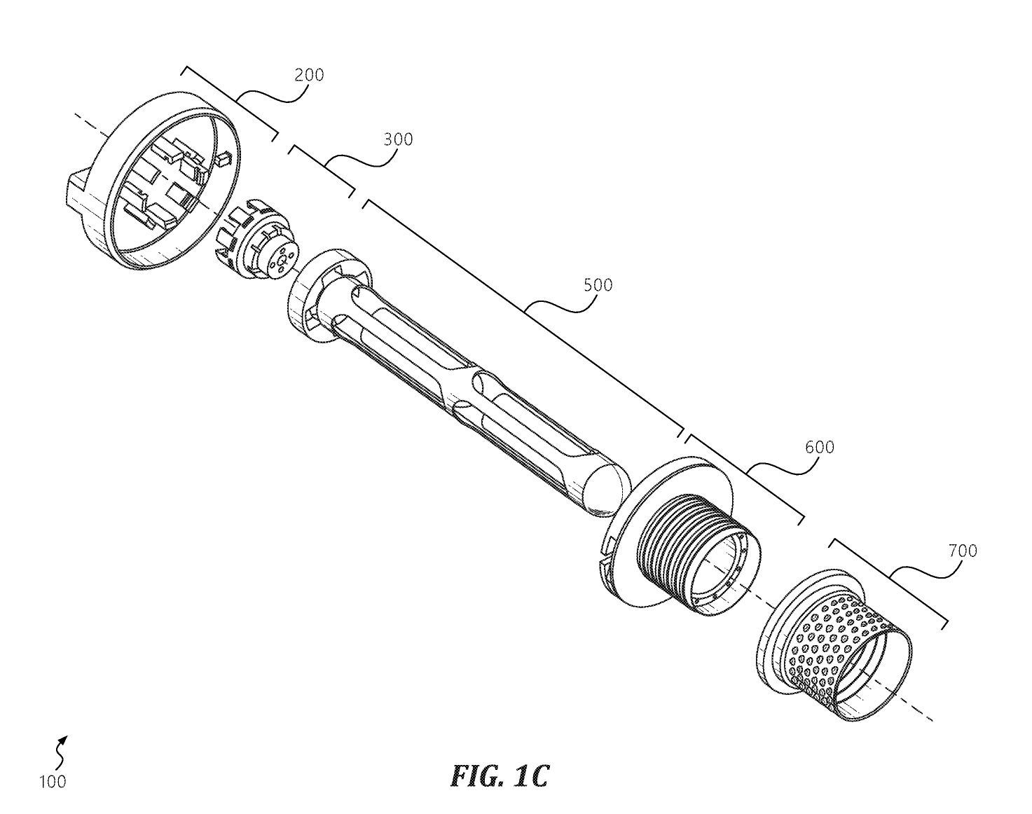

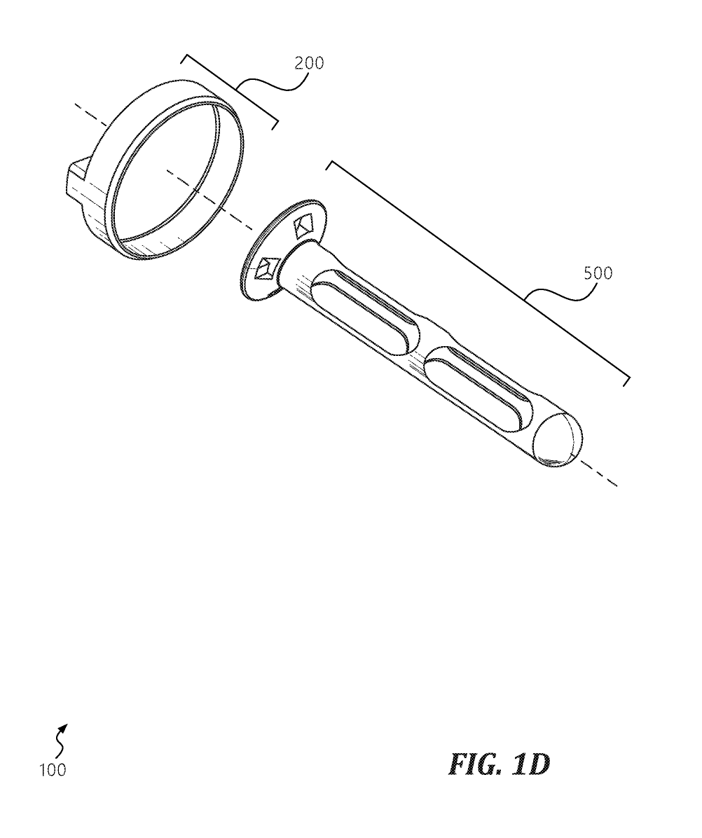

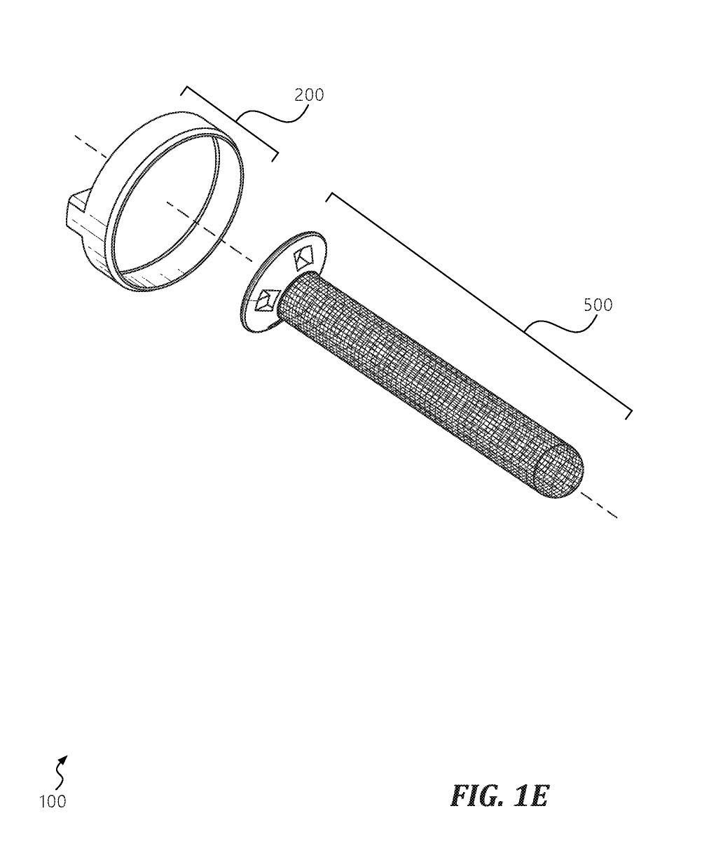

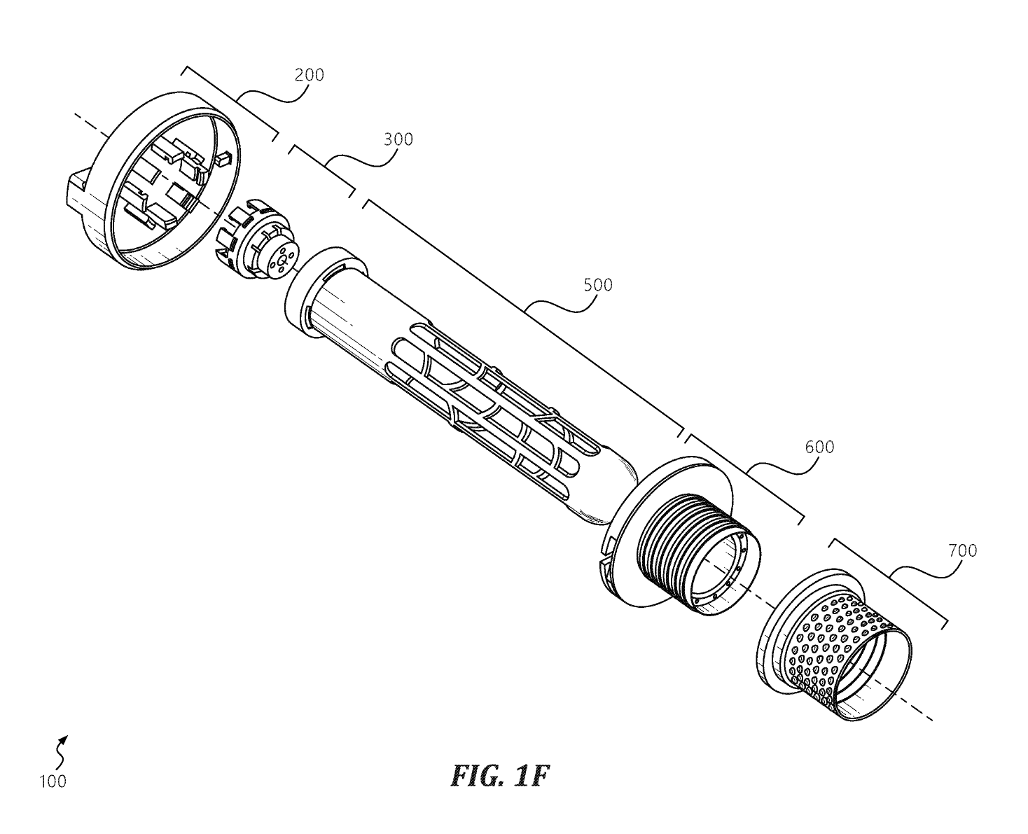

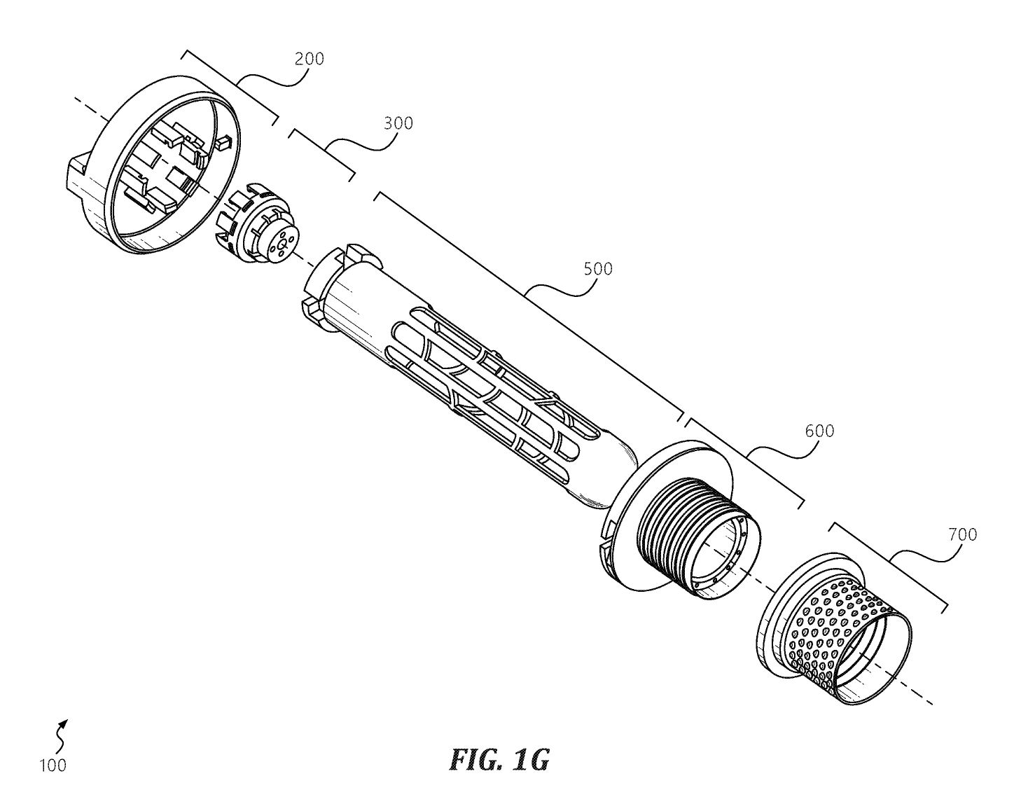

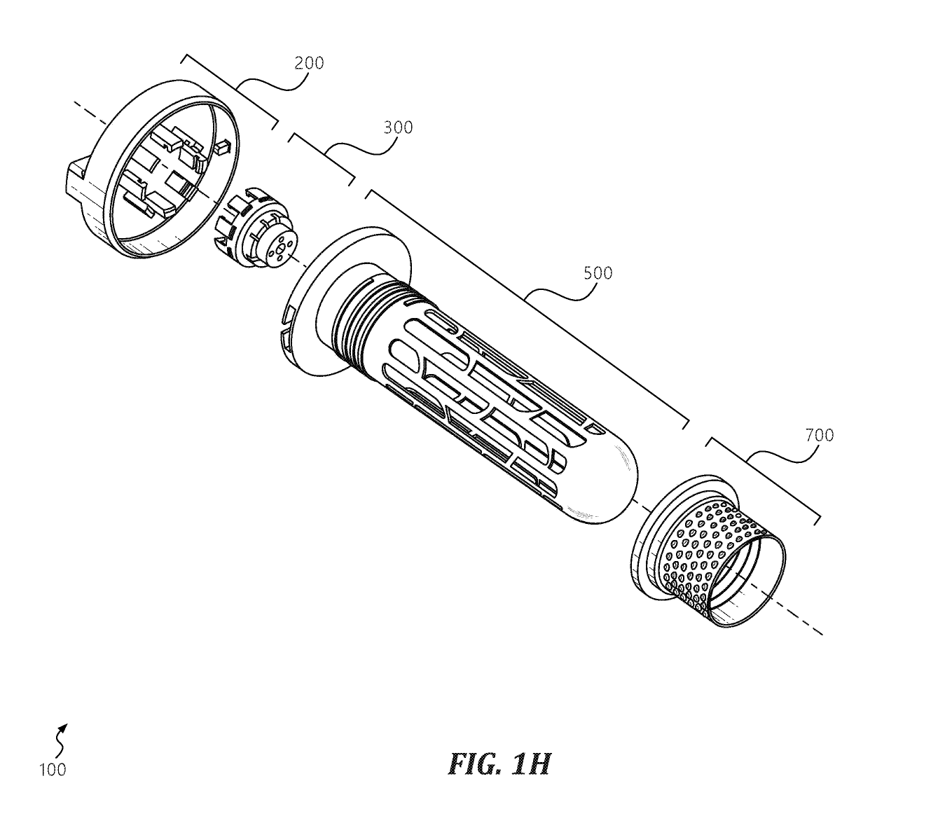

Consistent with embodiments of the present disclosure, a vehicle filler neck mounted fuel filter (“fuel filter”, “filter system”, or simply “system”) 100 may be provided, as illustrated in FIGS. 1A-1F. A vehicle filler neck mounted fuel filter 100 may be used to provide a particulate-removing filtration stage at the point of entry for fuel filling (commonly a gas pump). The terms “gas”, “gas station”, “gas pump”, and “gas tank”, are used in the broad sense of common parlance, and include various fuel compositions such as gasoline fuel, diesel fuel, biodiesel fuel, ethanol, kerosene, fuel oil, fuel blends, etc., as well as various different filling and storage mechanisms.

In an embodiment, system 100 can comprise a compression sleeve 700 that can fit in a filler neck of a vehicle. The filler neck can be the input point for a gas nozzle. The system 100 can include a filter holder 600 that can fit inside the inner wall of the filler neck hole 710. It can also include a filter tube 500 that can be inserted through the filter holder hole 610 and seat on the filter holder seating ring 610. The filter tube 500 can include filter mesh 550, which can facilitate the fuel filtering function of system 100. The filter tube 500 can be structurally supported by filter lattice 540. In one example, a cap 200 can seal and secure system 100 in the vehicle's fuel system, which may prevent or mitigate the egress of fluids (e.g. liquid fuel, fuel vapors, or other gasses) from the fuel tank. For example, fuel can be pumped through, and filtered by, system 100 by first removing the cap 200 and then inserting a fuel pump's fuel filler nozzle into the filter tube mouth 510 and then pumping the gas.

In another embodiment, system 100 can comprise a compression sleeve 700, with a filter tube 500 going through and seating against the compression sleeve hole 710. In one example, this can be done without a filter holder 600. In such an embodiment, threading features 630 that might otherwise be found on a filter holder 600 may be found as threading features 530 on the filter tube 500 itself. In yet another embodiment, system 100 may not comprise a cap 200, and/or may not comprise a pressure valve system (e.g. valve casing 300 and pressure valve assembly 400).

In yet another embodiment, system 100 can comprise a filter tube 500 with a flexible filter mesh 550 but without filter lattice 540. In such an embodiment, the filter tube 500 may be inserted through the filter holder 600 (or compression sleeve 700). This can be accomplished, in an example, without exerting force on the filter tube 500 at the end closest to the filter tube seating ring 520. Instead, the user can push the mesh 550 itself through by using an assisting rod that is inserted through the filter tube mouth 510 to the (distal) tip 580 of the filter mesh 550.

Filter system 100 can be mounted into the filler neck (i.e., the opening to the gas tank, into which fuel is pumped) of a vehicle. Filler necks frequently have an entry point diameter smaller than 2 inches. In various embodiments, filler necks may be sized to accommodate fuel filler nozzles having diameters of approximately, e.g., 13/16 inches (some gasoline nozzles), 15/16 inches (some diesel nozzles), or 1¼ inches (some high flow-rate diesel nozzles). System 100 can be dimensioned to both a) securely fit into such varied filler neck entry points, while also b) allowing ingress of the respective filler nozzle into the opening so that the vehicle can be fueled.

The exterior and interior diameters of the components that are inserted into the filler neck can accommodate various fueling regimes. For example, a “noncommercial” (e.g. passenger vehicle and light duty truck) gasoline or diesel fueling regime may have a slower maximum flow rate and narrower diameter filler nozzle than a “commercial” (e.g. tractor trailer) diesel fueling regime. The maximum flow rates may be set by law or regulation to be lower than the fuel filling pump's maximum physical capacity to dispense fuel. Some noncommercial fuelling regimes may have maximum flow rates such as 10 gal/min, 30 L/min, 50 L/min, etc. Some commercial fuelling regimes may have maximum flow rates such as 35 gal/min, 90 L/min, 130 L/min, etc. System 100 can have component dimensions and filter tube 500 characteristics to accommodate the sizes and flow rates of these various fueling regimes and others in various embodiments. The capacity for even higher flow rate fueling regimes (e.g., for watercraft, aircraft, heavy construction vehicles, or military vehicles) is also contemplated in various embodiments of system 100.

Referring now to FIGS. 1A-1I, there are shown filter systems 100 consistent with embodiments of the present disclosure. A filter system 100 can accommodate numerous types of vehicle fuel systems, fuel compositions, filler neck diameters, entry point configurations (e.g., screw cap, capless, built-in misfueling prevention features), and backpressure mitigation needs. Filter system 100 can accommodate gasoline engine vehicles such as cars and motorcycles (see, for example FIGS. 1A-E), non-commercial diesel engine vehicles such as pickup trucks (see, for example FIGS. 1F-G), and commercial diesel engine vehicles such as tractors and tractor trailers (see, for example FIGS. 1H-I).

Embodiments of fuel filter 100 can operate with a filter tube 500 and one or more additional components such as valve casing 300, filter holder 600, and compression sleeve 700. Some embodiments can be configured to operate as a “standalone” fuel filter 100 consisting of just a filter tube 500.

Other vehicles/equipment (e.g. lawn mowers, RVs, ATVs, boats, alternative fuel vehicles that utilize biodiesel, ethanol, kerosene, etc.) may be consistent with certain of the above categories and/or be accommodated with their own configurations in various embodiments.

Filter system 100 can also incorporate anti-static features. This can be accomplished through material selection and features designed to suppress or eliminate the introduction of static arcs. Such instances of electrical discharge or sparking could pose a hazard in the vicinity of the gas tank and fuel dispensing equipment. Thus the individual components and system 100 as a whole can be configured to inhibit triboelectric charging and static discharge. As examples, this can be done with naturally anti-static structural materials, incorporation of static preventing agents into component materials, anti-static coatings, various physical arrangements, and other anti-triboelectric mechanisms.

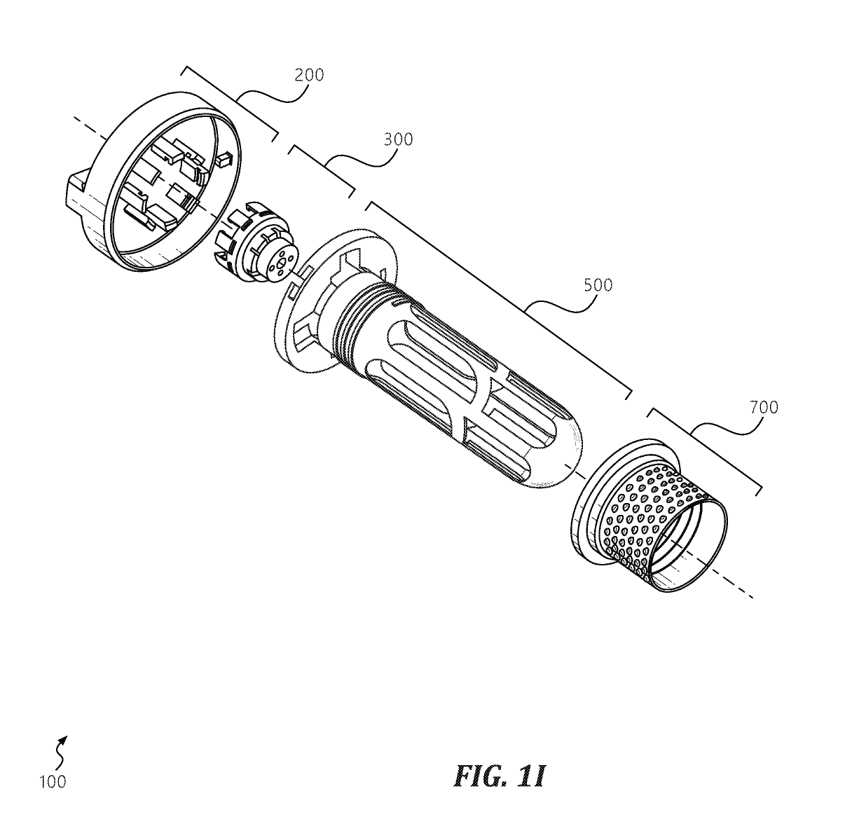

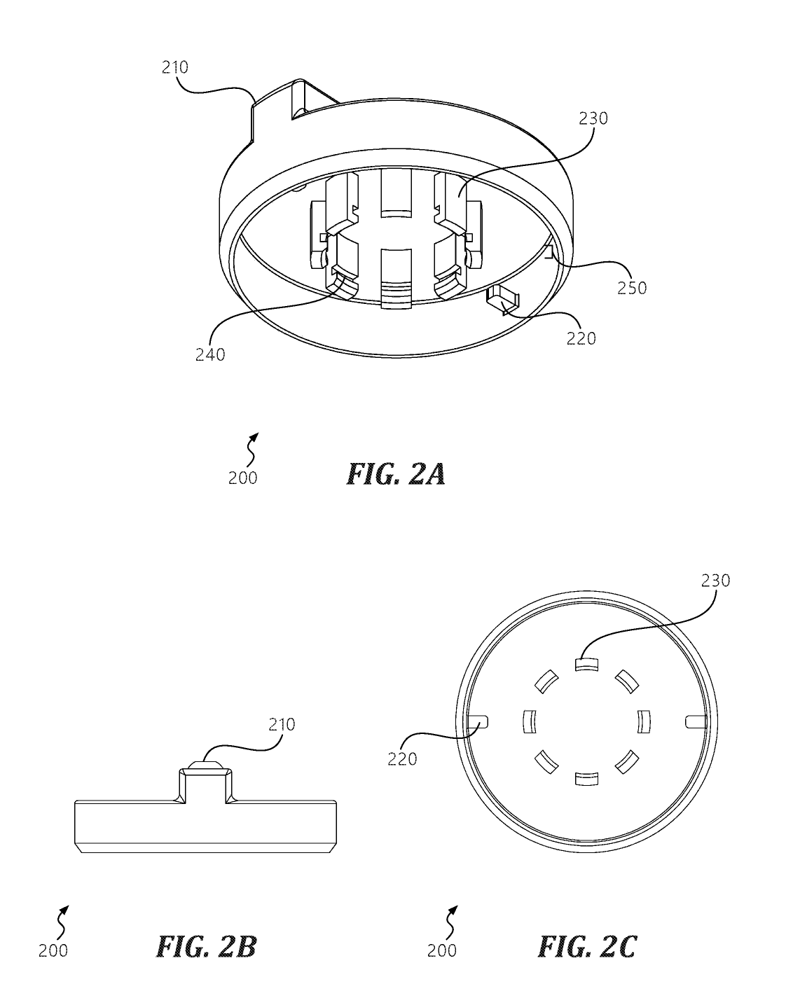

Referring now to FIGS. 2A-C, there is shown a cap 200 consistent with embodiments of the present disclosure. A cap 200 can have a handle 210 used for removing and affixing the cap 200. Cap 200 can have a hole or other affixing mechanism for a tether 800. Some embodiments may not have or require a cap 200, and some embodiments may be configured to interface with a vehicle-integral cap (e.g., as part of the door to the filler neck compartment. Cap 200 can have a gasket 250 (e.g., a ring gasket in approximately the space indicated) to help effect a seal between system 100 and the vehicle's fueling system.

In some embodiments, cap 200 can be a dedicated component of the filter system 100. In other embodiments, cap 200 may be the vehicle manufacturer-provided gas cap, or one provided by the vehicle operator, or be integrated with the fuel door. System 100 can work in conjunction with its own cap 200, any of the other cap 200 regimes listed above, and many other configurations of gas tank entry chamber.

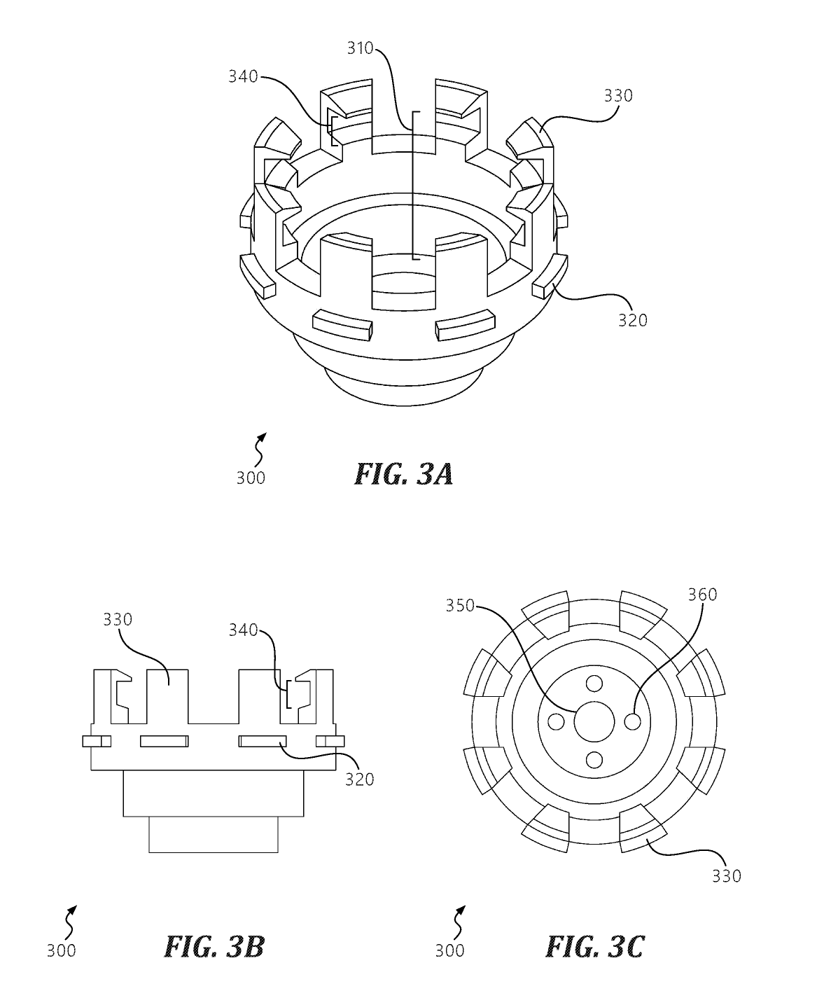

Referring now to FIGS. 3A-C, there is shown a valve casing 300 consistent with embodiments of the present disclosure. Valve casing 300 can have a valve cavity 310 that accommodates a pressure valve assembly 400. Further, it may have one or more retention tabs 320 that can interface with one or more valve casing retention posts 230 on the cap 200, so as to secure the valve casing 300 and its attendant pressure valve assembly 400 in place on the cap 200 (and in spatial relation to the filter tube mouth 510 with which it can also interface). Valve casing 300 may have one or more pressure valve holes 350, 360 that can be part of a system for alleviating backpressure from the gas tank. There may be one primary hole 350, an array of same sized holes 360, a large 350 and one or more smaller 360 holes, or other shapes or configurations (e.g. slit vents, square ports, or any other shape suitable for the backpressure mitigation function).

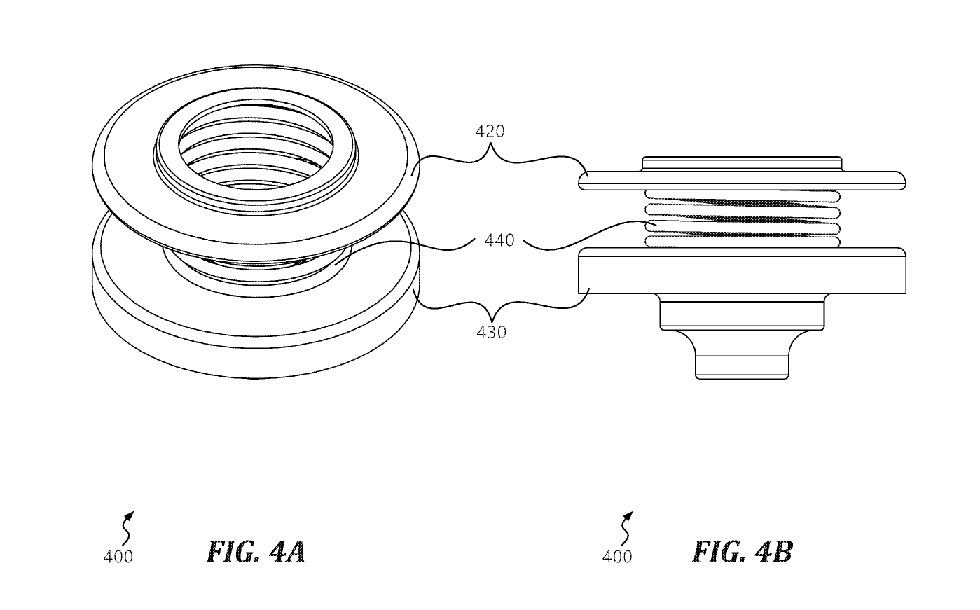

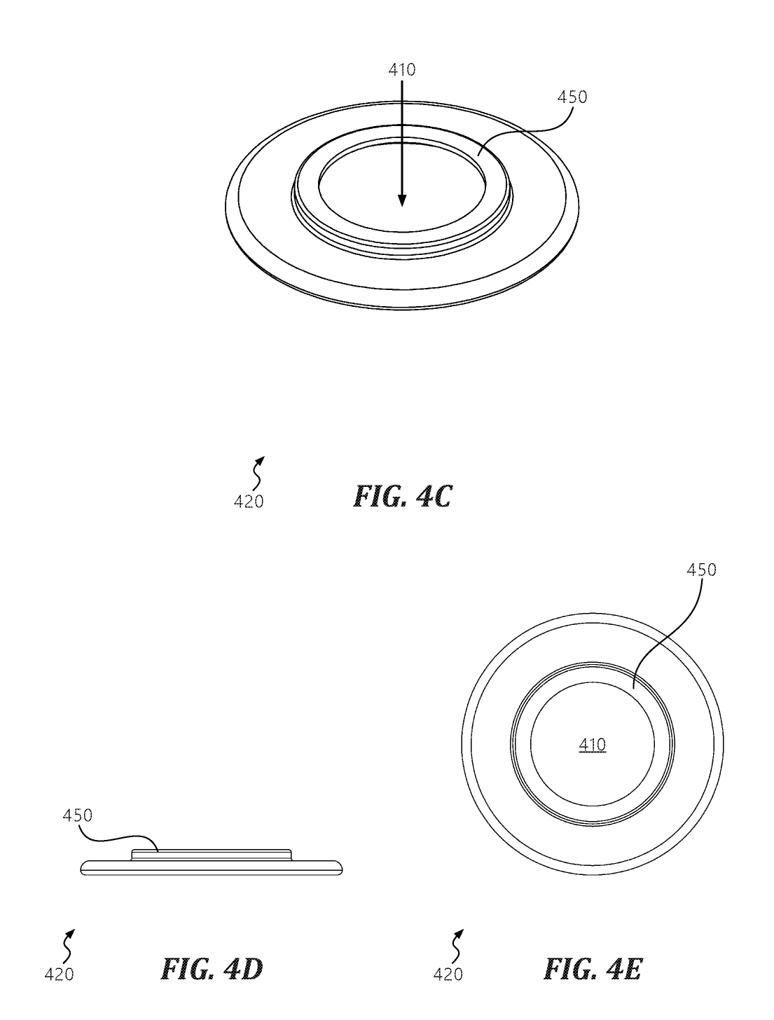

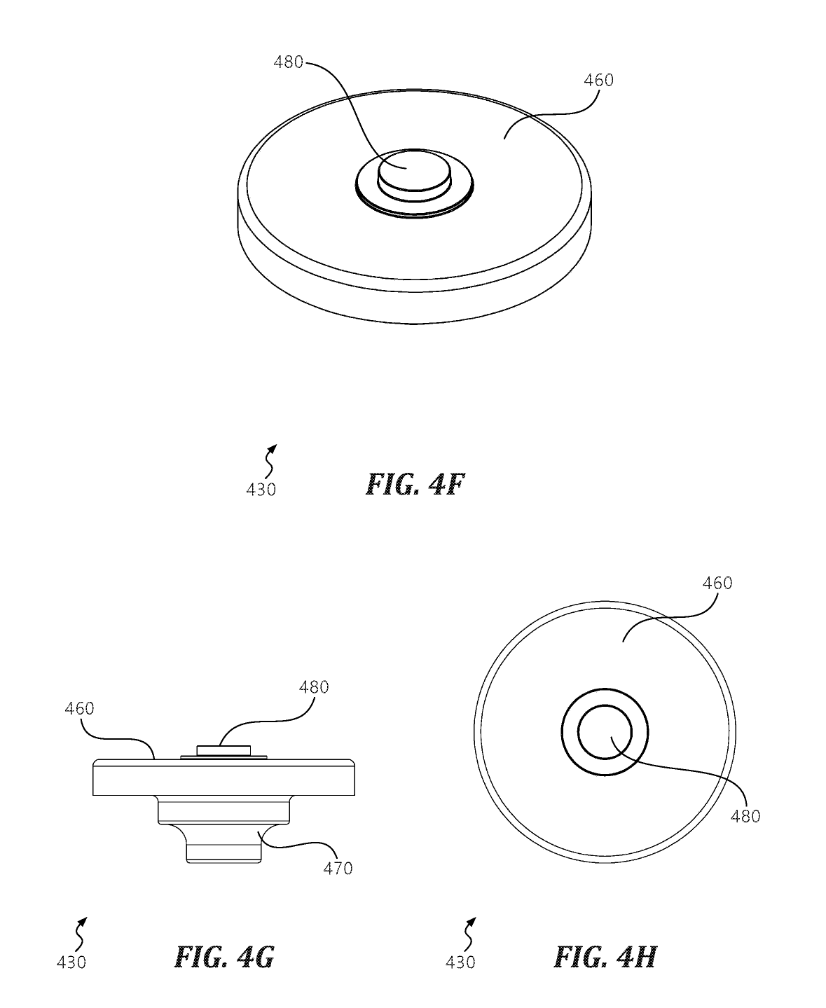

Referring now to FIGS. 4A-H, there is shown a pressure valve assembly 400 consistent with embodiments of the present disclosure. A pressure valve assembly 400 can include a spring retention ring 420, pressure valve base 430, valve interior spring 440, and a valve bottom spring. In an embodiment, spring retention ring 420 can be employed with the spring housing 450 upward protruding, as shown in FIGS. 4A-D, such that the upper portion of spring 440 seats in the corresponding “trough” on the underside of spring retention ring 420. In another embodiment, spring retention ring 420 can be employed upside-down from the views shown in FIGS. 4A-D, such that upper portion of spring 440 seats around the downward protruding spring housing 450.

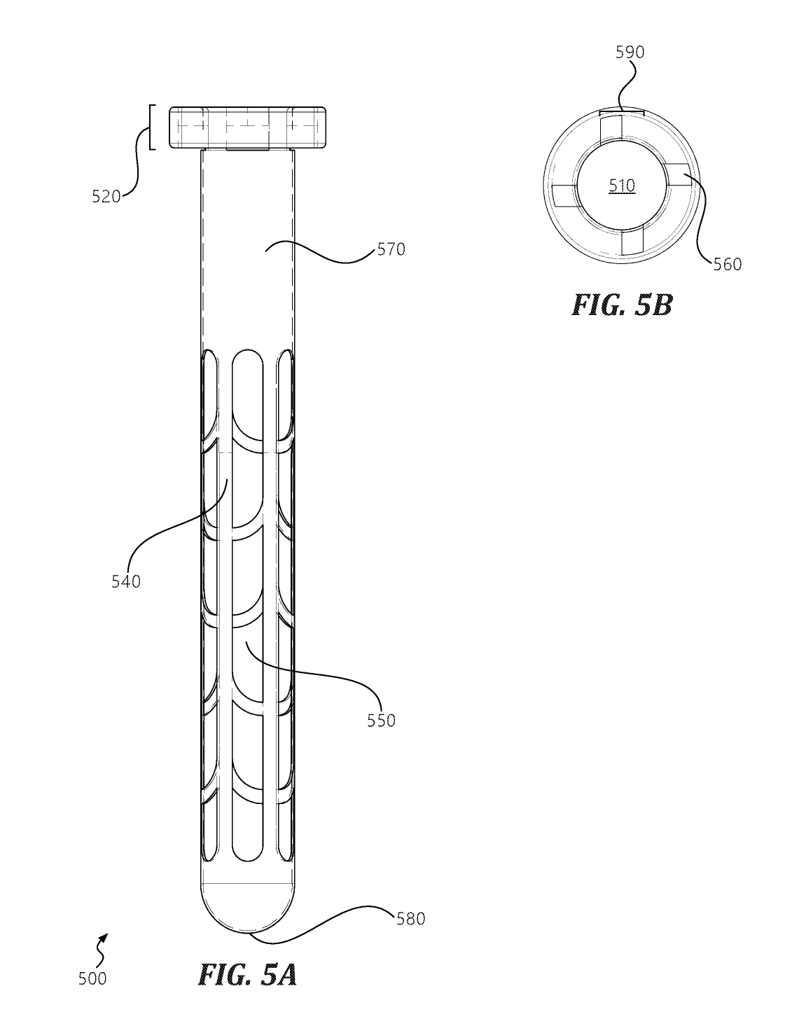

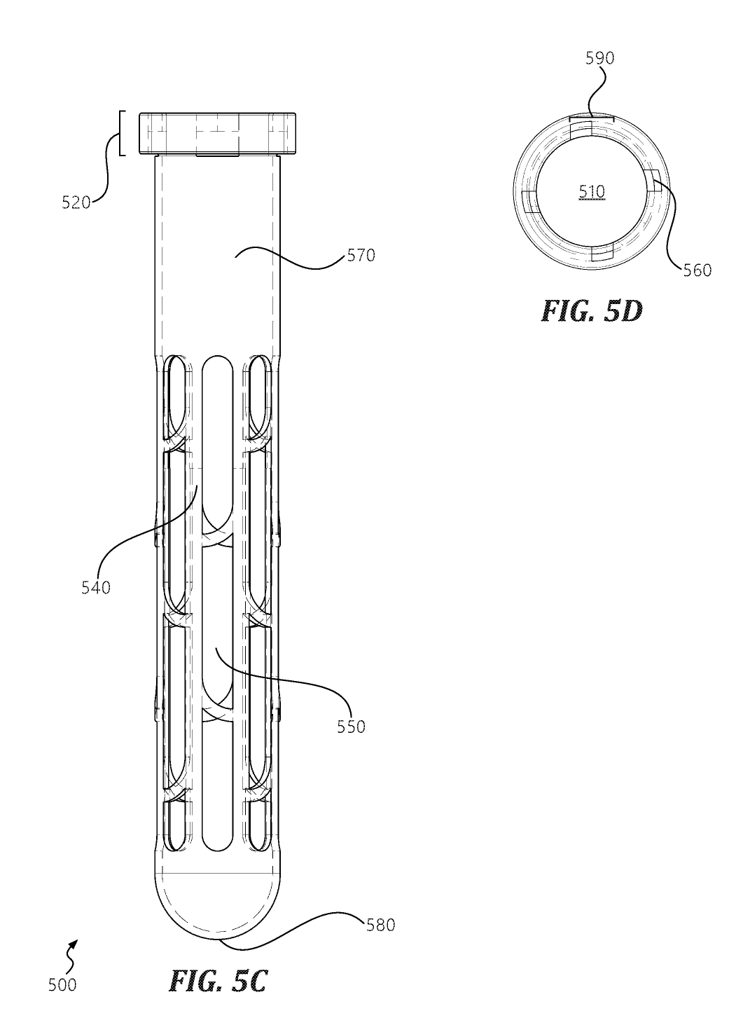

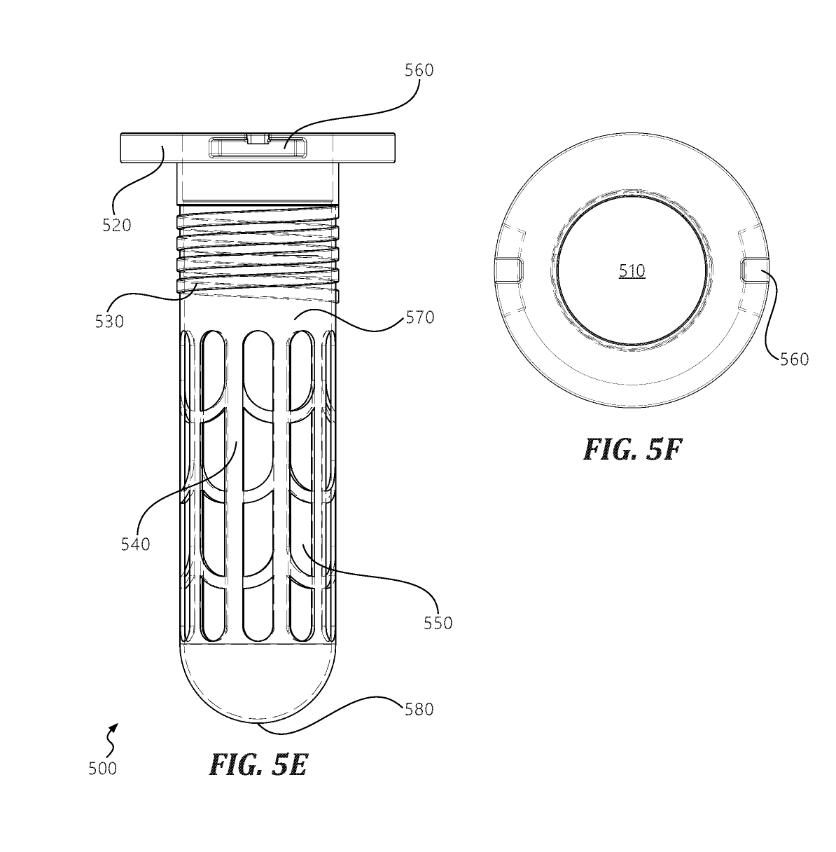

Referring now to FIGS. 5A-F, there are shown filter tubes 500 consistent with embodiments of the present disclosure. Filter tubes 500 and their constituent components (e.g. seating ring 520) can be of varying lengths, tube diameters, and shapes to accommodate different types and models of vehicle, fuel composition, flow rates, etc.

Note that different shapes and configurations of filter tube seating ring 520 (solid wall, separated wall, stacked double ring, notched single ring, cylindrical, conical, off-center, etc.) can address varying needs. In various embodiments, filter tube 500 may have one or more pressure relief channels 590 that can be (or be part of) a mitigating feature for backpressure buildup from the gas tank.

Some embodiments, such as those depicted in FIGS. 1D-E, may be configured to operate with a cap that is supplied by the vehicle operator (e.g. an OEM cap or fuel door-attached cap-like structure). In such embodiments, the seating ring 520 may have a conical shape, which can help fuel filter 100 fit within the confines of the cap and/or gas tank entry chamber.

In order to accommodate the wide variety spatial configurations of vehicle fuel doors, caps, and gas tank entry chambers, or due to other factors, embodiments may comprise seating rings 520 that are non-circular in shape (e.g. ovoid, polygonal, irregular) and/or off-center from the filter tube shaft 570.

Mesh 550 can be sized and patterned to filter out particulate matter above a desired size threshold. Mesh 550 can have anti-foaming qualities. In various embodiments, mesh 550 can incorporate or form structural components that serve the role of filter lattice 540. Mesh 550 may be embedded in (and thus attached to) the bottom of seating ring 520. This may occur as part of the manufacturing process.

Lattices 540 can come in a wide variety of configurations; a few of the many possibilities are depicted in FIGS. 1A, 1C, and 1H. In some embodiments, mesh 550 can be used without filter lattice 540, as is depicted in FIG. 1E. In mesh-only embodiments, an assistive tool (e.g. a rod) may be inserted into the filter tube 500 in order to feed the non-rigid filter tube shaft 570. Mesh 550 may be molded to, affixed to, integrated with, or embedded in lattice 540. This may occur as part of the manufacturing process. In one example, a cylindrical mesh 550 may undergo an injection molding process that forms the supporting lattice 540, these components together forming the filter tube shaft 570.

The filtration feature represented diagrammatically by mesh 550 may also be accomplished by configurations other than a mesh-patterned material—e.g. depth filtering.

Filer tube 500 can comprise a removal mechanism such as one or more removal notches 560. Such a feature can allow a user to manually, or with the help of a tool, extricate a filter tube 500 from the filler neck of a vehicle.

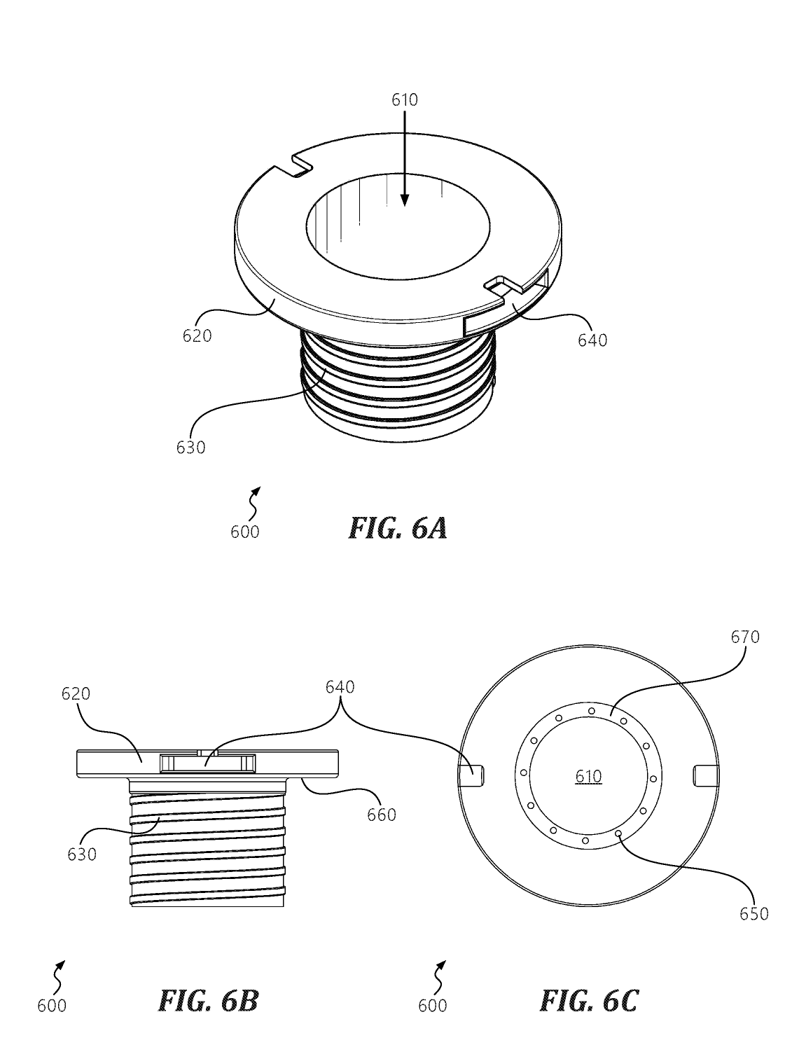

Referring now to FIGS. 6A-C, there is shown a filter holder 600 consistent with embodiments of the present disclosure. A filter holder 600 can include a hole 610 through its cylindrical center. A filter holder 600 can also include a filter holder seating ring 620, the underside (or filter holder lip 660) of which can seat against the area outside the entrance to the vehicle's filler neck. A filter holder 600 can include filter tube seating shelf 670 configured to interface with the filter tube seating ring 520 of a filter tube 500.

A filter tube holder 600 may be inserted into the through hole 710 in a the compression sleeve 700. A filter tube holder 600 can act as a positioning guide, mechanical securing element, and stopping point (i.e. preventing filter tube ingress down the filler neck and into the gas tank) for a filter tube 500. A filter tube holder 600 can have threading 630, and this threading 630 can interface with corresponding threading 730 on a compression sleeve 700.

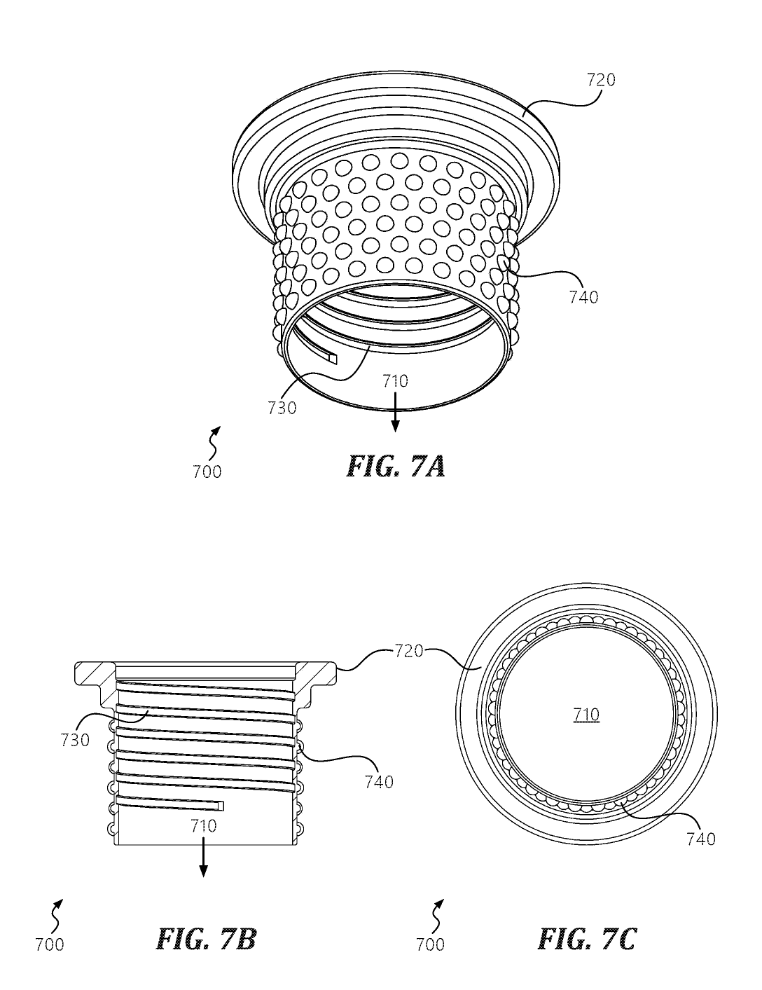

Referring now to FIGS. 7A-C, there is shown a compression sleeve 700 consistent with embodiments of the present disclosure. A compression sleeve 700 can be made of a flexible or semi-rigid polymer material that can be inserted into the externally accessible mouth of a gas tank and down the filler neck, contacting the inner walls of the filler neck and leaving a through hole 710 for additional components (and of course, ultimately, fuel). In an embodiment, a compression sleeve 700 can be inserted into the filler neck, up to its compression sleeve seating ring 720. The compression sleeve 700 can be a feature that helps achieve a secure fit for system 100 in the filler neck, by, for example, constructing the compression sleeve's 700 out of a pliable or semi-flexible material, and/or by including compression features 740 such as bumps or protrusions on the outer surface of the compression sleeve 700.

A compression sleeve 700 can have compression features 740 that enhance the grip and sealing characteristics of the assembly, which can be beneficial in mechanically securing the assembly in place (against, e.g., vapor backpressure from the gas tank, or pulling forces experienced in fuel pump operation). Compression features 740 may, but need not, be a series of bumps, ridges, or protrusions. Additionally or alternatively, compression features 740 may comprise other suitable structures and combinations thereof.

A compression sleeve 700 may comprise a spring, inflation, or expansion mechanism that extends from an outer surface of filter tube 500 to actively tension system 100 against the interior wall of the filler neck. In some embodiments compression sleeve 700 may be detachable or otherwise separate from filter tube 500, while in other embodiments it may be integrated therewith. Compression sleeve 700 components may be variously detachable and integrated in some embodiments.

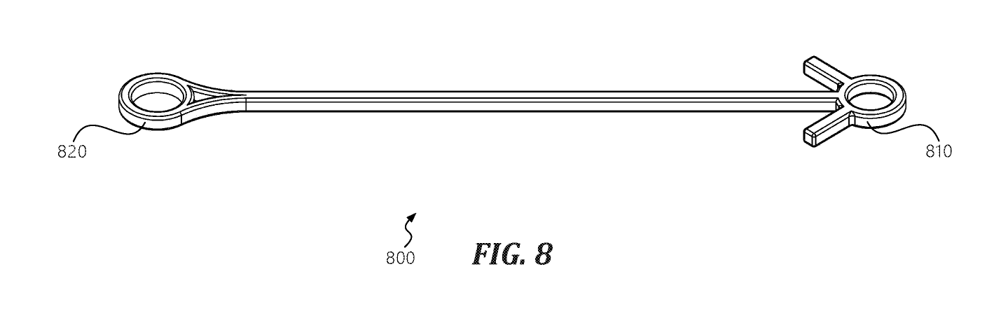

Referring now to FIG. 8, there is shown a tether 800 consistent with embodiments of the present disclosure. Tether 800 can be affixed to a cap 200 in order to prevent misplacement or loss of the cap 200.

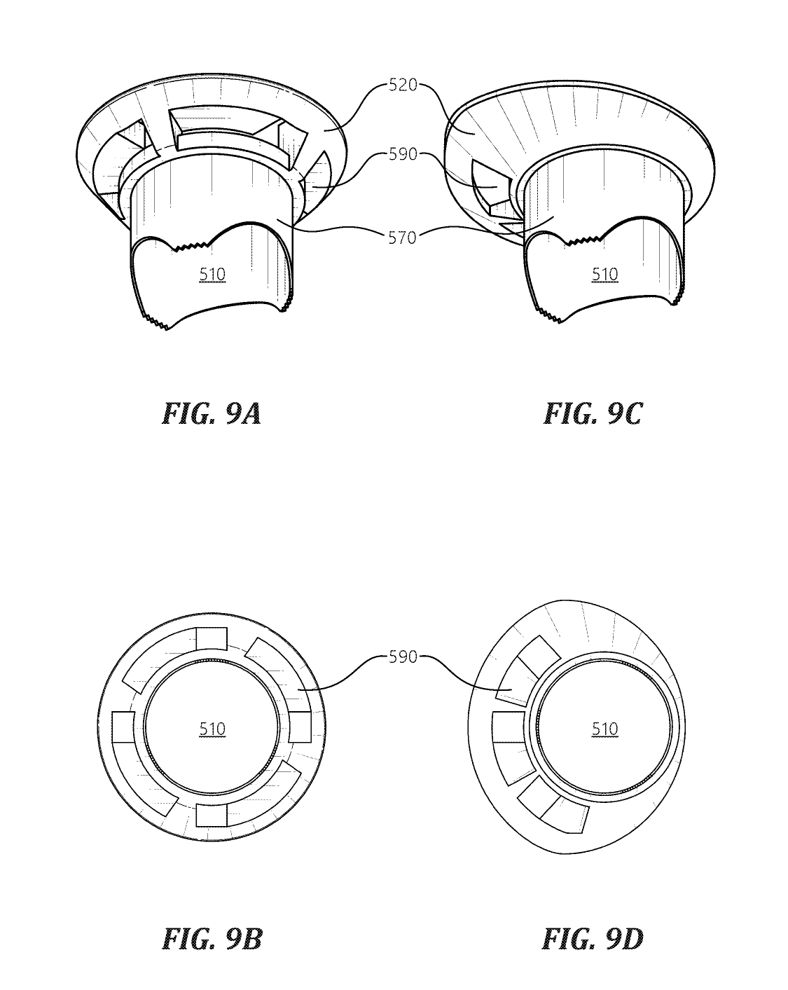

Referring now to FIG. 9A-D, there are shown filter tube seating rings 520 consistent with embodiments of the present disclosure (jagged lines indicate matter cut off from the depicted view). FIGS. 9A-B illustrate a filter tube seating ring 520 which may have a circular exterior face and a tapered profile from external face to shaft 570 (the shape when viewed from the side resembling a conical frustum). Pressure relief channels 590 may provide a gas flow channel connecting the interior of the filler neck with the exterior beyond the face of the seating ring 520. In some embodiments, various other components of system 100 may be shaped to interface with a seating ring 520 that has a tapered profile.

FIGS. 9C-D illustrate a filter tube seating ring 520 which may have an irregular-shaped exterior face and a tapered profile from external face to shaft 570, with the filter tube mouth 510 off-center with respect to the exterior face and pressure relief channels 590 arranged asymmetrically. Vehicles have a wide variety of filler neck entry point configurations. An off-center filter tube mouth 510 may assist in the proper seating and fitting of filter tube 500 into the filler neck of some vehicles. A seating ring 520 having a shape and arrangement of pressure relief channels 590 similar to that depicted in FIG. 9C may provide favorable seating and pressure relief characteristics with certain configurations of filler neck. Embodiments having any one or more of the following features need not have any one or more of the other listed features: an irregular-shaped exterior face, an off-center filter tube mouth 510, a tapered profile, or an asymmetrical arrangement of pressure relief channels 590.

In general, depicted or described variations in features may be found in combination with other depicted or described variations, whether or not such combination is itself depicted or described. Various aspects and components of system 100, depicted or described as separate may in some embodiments be combined, attached, integrally incorporated, etc. Likewise, various aspects and components may in some embodiments be separated into more or different components while still achieving similar functions and system 100 functionality.

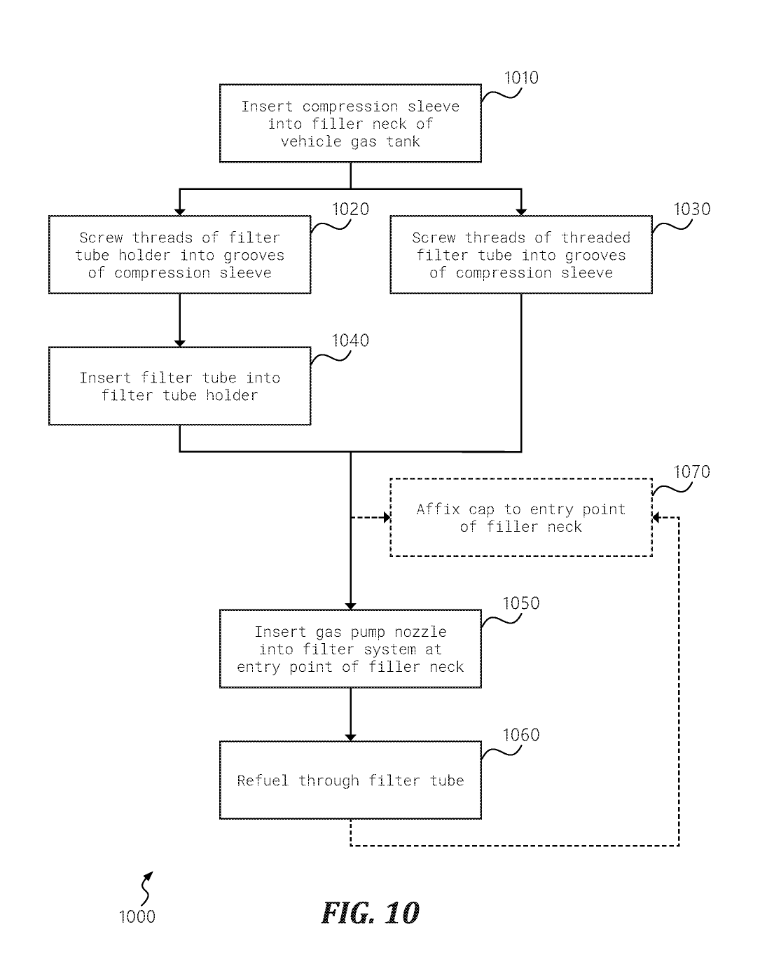

Referring now to FIG. 10, there is shown a method of installing and using a filter system 100 consistent with embodiments of the present disclosure. At step 1010, a compression sleeve 700 can be inserted in the filler neck of a vehicle, up to the compression sleeve seating ring 720. The outer wall of the compression sleeve 700 and/or its compression features 740 (if any) may contact the inner wall of the filler neck. The next step may be 1020 if system 100 comprises a filter holder 600, or step 1030 if system 100 does not comprise a filter holder 600 (e.g., when aspects of the filter tube 500 is configured to achieve various goals that could otherwise be achieved by a filter holder 600).

At step 1020, a filter holder 600 can be inserted into compression sleeve 700 up to filter holder seating ring 620 (i.e., with the bottom lip 660 of seating ring 620 contacting the upper surface of seating ring 720). The insertion process may include simply translational (straight in) motion, or may also include rotational (twisting) motion. The latter may be the case, e.g., in an embodiment where the filter holder 600 comprises threading features 630. In such an embodiment, compression sleeve 700 may comprise threading features 730. Threading features 630 and 730 may be designed to physically interface.

At step 1040, a filter tube 500 can be inserted into filter holder 600. In an embodiment, filter tube 500 can have a seating ring 520 that can seat against a filter tube seating shelf feature 670 of filter holder 600. In embodiments where filter tube 500 lacks supporting lattice 540, the insertion process may involve an aid such as a push rod.

At step 1030, a filter tube 500 (which may have integral features for interfacing with a compression sleeve 700) can be inserted through the hole 710 in the compression sleeve 700. The insertion process may include simply translational (straight in) motion, or may also include rotational (twisting) motion.

At step 1050, a user can insert the fuel filler nozzle of a fuel pump into the filter tube mouth 510 that is now the entry point into the vehicle fuel system.

At step 1060, a user can pump fuel through system 100, thereby passing the fuel stream through the mesh 550 and its filtrative properties.

At step 1070, a user may optionally place or replace the cap 200 in position affixed to the vehicle. This step may not be necessary or possible, as with embodiments of system 100 that do not comprise a cap 200.

The order of steps presented herein and in the figures are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only.

Other examples of the disclosure will be apparent to those skilled in the art from consideration of the specification and practice of the examples disclosed herein. The examples are not limited to use with a particular vehicle type, and may be applied to the fueling of any compatible vehicle.

Though some of the described methods have been presented as a series of steps, it should be appreciated that one or more steps can occur simultaneously, in an overlapping fashion, or in a different order. The order of steps presented is only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

1. A vehicle filler neck mounted fuel filter system comprising:
a filter tube comprising:
a proximal end and a distal end;
a filter tube mouth at the proximal end of the filter tube; and
a filtration element distal to the filter tube mouth; and
a securing mechanism for securing the filter tube into a filler neck of a vehicle, the filler neck having an entry point at its proximal end and a fuel tank at its distal end, wherein the filter tube is configured to fit through the entry point of the filler neck, further wherein the filter tube is configured to interface with the securing mechanism at the entry point of the filler neck to prevent the filter tube from ingress into a fuel tank of the vehicle.

2. The vehicle filler neck mounted fuel filter system of claim 1, wherein the entry point of the filler neck has a diameter between ¼ inch and 2 inches.

3. The vehicle filler neck mounted fuel filter system of claim 2, wherein the entry point of the filler neck has a diameter sized to accommodate a fuel filler nozzle having a diameter of between ¾ inch and 1 inch.

4. The vehicle filler neck mounted fuel filter system of claim 2, wherein the entry point of the filler neck has a diameter sized to accommodate a fuel filler nozzle having a diameter of between 1⅛ inch and 1⅜ inch.

5. The vehicle filler neck mounted fuel filter system of claim 1, further configured to accommodate sustained fuel pump flow rates of at least 35 gallons/minute without backflow of fuel.

6. The vehicle filler neck mounted fuel filter system of claim 1, further comprising a cap configured to block egress of fluids from the filter tube, wherein the cap comprises at least one of a vehicle-mounted cap and a vehicle filler neck mounted fuel filter system cap component.

7. The vehicle filler neck mounted fuel filter system of claim 1, further comprising a pressure valve assembly configured to interface with the filter tube mouth.

8. The vehicle filler neck mounted fuel filter system of claim 7, wherein the pressure valve assembly comprises a spring retention ring, a pressure valve base, and at least one spring.

9. The vehicle filler neck mounted fuel filter system of claim 7, further comprising a valve casing configured to interface with the pressure valve assembly.

10. The vehicle filler neck mounted fuel filter system of claim 1, further comprising a compression sleeve configured to interface with an inner wall of the filler neck.

11. The vehicle filler neck mounted fuel filter system of claim 1, wherein the filter tube further comprises a filter tube seating ring having an exterior face, wherein the filter tube mouth proceeds through the exterior face to the filtration element.

12. The vehicle filler neck mounted fuel filter system of claim 11, wherein the filter tube mouth is not centered with respect to the exterior face of the filter tube seating ring.

13. The vehicle filler neck mounted fuel filter system of claim 11, wherein the filter tube seating ring, when viewed from the side, is shaped substantially like a conical frustum.

14. The vehicle filler neck mounted fuel filter system of claim 1, further comprising a pressure relief channel that provides a gas flow channel between an area disposed within the filler neck and an area proximal to the proximal end of the filter tube.

15. The vehicle filler neck mounted fuel filter system of claim 1, wherein the filtration element comprises filter mesh.

16. The vehicle filler neck mounted fuel filter system of claim 15, wherein the filtration element comprises filter lattice supporting the filter mesh.

17. A vehicle filler neck mounted fuel filter system comprising:
a valve casing comprising:
a valve cavity configured to interface with a pressure valve assembly;
at least one valve casing retention tab configured to interface with the at least one valve casing retention post;
at least one pressure valve retention post, the at least one pressure valve retention post comprising at least one notch; and
at least one pressure valve hole,
a pressure valve assembly comprising:
a spring retention ring;
a valve interior spring;
a pressure valve base; and
a valve bottom spring,
a filter tube comprising:
a filter tube mouth;
a filter tube seating ring comprising:
an exterior face;
at least one removal notch; and
at least one pressure relief channel,
at least one filter lattice element; and
at least one filter mesh element,
a filter holder comprising:
a filter holder seating ring;
at least one locking mechanism;
at least one pressure valve hole;
a filter tube seating shelf; and
at least one exterior threading element, and
a compression sleeve comprising:
a compression sleeve seating ring;
at least one compression feature; and
at least one interior threading element.

18. The vehicle filler neck mounted fuel filter system of claim 17, wherein the filter tube mouth is not centered with respect to the exterior face of the filter tube seating ring.

19. The vehicle filler neck mounted fuel filter system of claim 17, wherein the filter tube seating ring, when viewed from the side, is shaped substantially like a conical frustum.

20. A method for installing a vehicle filler neck mounted fuel filter system comprising:
inserting a compression sleeve into the filler neck of a vehicle's gas tank; and
mounting a filter tube by at least one of:
screwing the external threading of the filter tube into the internal threading of the compression sleeve; and
screwing the external threading of a filter tube holder into the internal threading of the compression sleeve, and further inserting the filter tube into the filter tube holder to interface with the filter tube holder's filter tube seating shelf.
